(19) United States
(12) Patent Application Publication
(10) Pub. No.: US 2015/0294047 A1
(43) Pub. Date: Oct. 15, 2015

(54) System for Continuous Modeling and Dissemination of Threat Zones Associated with Hazardous Release Materials

(71) Applicant: SimCenter Enterprises, Inc., Chattanooga, TN (US)

(72) Inventors: Timothy M. Walsh, Ooltewah, TN (US); Adam Cofer, Signal Mountain, TN (US); Ming Zhao, Chattanooga, TN (US); Andrew Duncan, Lakesite, TN (US); Kimberly Donn Ingram, Charleston, TN (US); Henry McDonald, Glastonbury, CT (US); William Brock, Chattanooga, TN (US)

(21) Appl. No.: 14/683,362

(22) Filed: Apr. 10, 2015

Related U.S. Application Data
(60) Provisional application No. 61/977,624, filed on Apr. 10, 2014.

(51) Int. Cl. G06F 17/50; H04L 29/08

(52) U.S. Cl. CPC G06F 17/5009; H04L 67/02

(57) ABSTRACT

A computer cloud implemented method and system for manually or electronically inputting real time geophysical location data, physical properties of the substance, associated release parameters of the physical substance into the open earth atmosphere, and weather data (historical, current or future forecasted data) on the assumption the release of the substance occurred at the same instantaneous time the weather data was entered and repeatedly calculating the results with new updated data for any of the above data parameters using algorithmic modeling of toxic substance releases to compute a model of the predicted toxic threat zone (Gaussian model) or a model of the predicted toxic plume pathway and associated exposure levels (CFD) and rendering the results electronically for visual display in, on or over any multi-coordinate display system in any medium and distributed or distributable to users electronically or manually when input parameters are updated, and displaying other related information associated with toxic substance release, are provided.

The present application claims priority to U.S. Patent application No. 61/977,624 filed Apr. 10, 2014.

### FIELD OF THE INVENTION

In the event of a release in the earth's atmosphere of dangerous toxic substances, whether chemical, biological, radiological, or explosive, emergency response personnel frequently have little situational awareness. There are three critical success factors for gaining situational awareness: time, accuracy, and communication.

Time is related to learning about the toxic release event as soon as possible after the event occurred. The sooner an effective response can be organized, the higher the likelihood that lives will be saved and property protected.

Accuracy refers to knowing the cause of the event and the nature of the potential threat to the first responders and the community. For the release of a toxic substance into the atmosphere, it is important to know the identity of the toxic substance, the amount of substance being released and the current weather data such as wind direction and speed. These factors determine how the toxic substance will be convected over the community.

Communication refers to the capability to timely convey accurate actionable information to first responders and affected citizens to ensure their safety and to mount an informed effective response to mitigate the hazardous toxic substance release.

Presently, the most typical incident response is largely reactive, as reflected in FIG. 1.

As illustrated in Step 1 of FIG. 1, in the event of a hazardous toxic substance release at a fixed facility location or from a mobile transport container, the alarm is often raised by a 911 call providing first responders with little or no information about the nature of the incident. By the time a call is received by the 911 operator, as much as ten to twenty minutes have passed after the time of the initial (“time zero”) release of the toxic substance. In Step 2, the 911 operator dispatches the first responders, however, it usually takes first responders an additional twenty to forty minutes to learn about the type of toxic substance and the amount of the release.

Step 3 illustrates a HazMat technician determining the toxic threat zone. This zone is commonly calculated using the CAMEO/ALOHA software application developed by the Environmental Protection Agency (EPA) and the National Oceanic and Atmospheric Administration (NOAA). Using ALOHA, the HazMat technician needs another two to five minutes to manually enter the critical data along with local weather conditions and calculate the toxic threat zone.

From the time of the incident to the time a HazMat technician will often require thirty minutes or more to develop confident situational awareness. Once the toxic threat zone is calculated, it is only displayed on the device the HazMat technician is using. This does not facilitate communication of a Common Operating Picture to the other first responders and citizens who need the information the most. Due to the above limitations and untimely availability of accurate data, HazMat technicians rarely take the time to use CAMEO/ALOHA to compute the toxic threat zone. Instead, they may default to the prescribed procedures in the Emergency Response Guidebook 2012: A Guidebook for First Responders during the Initial Phase of a Dangerous Goods/Hazardous Materials Transportation published by the U.S. Department of Transportation. As a result, additional time is lost.

Hence, there is a long felt need for a method and system, to address the need for accurate and real time situational awareness for all first responders in the event of a toxic substance release.

### DESCRIPTION OF THE DRAWINGS

FIG. 1 is a schematic representation of prior art reactive incident response steps;

FIG. 2 is a schematic of a proactive incident response steps;

FIG. 3 is an exemplary user interface of threat zones on a map with a hazardous site's details in a pop-up window;

FIG. 4 is an exemplary display of a map with a toxic threat zone;

FIG. 5 is an architecture of the components of an implementation of an exemplary method and system for practicing the invention.

A method and system is provided to calculate, communicate and display a real time model of the toxic threat zone to a multiplicity of users on their web browser or mobile device in the event of a toxic substance release. A method and system optimally utilizes the interne for manually or electronically pre-entering geographic location data, physical properties of the toxic substance, associated release parameters of the physical substance when dispersed into the atmosphere, and historical, current or forecast weather on the assumption the release of the substance occurred at the same time the weather data was entered. The system may continually calculate these results with updated data for the above parameters (and especially weather related parameters) using algorithmic modeling of toxic substance releases to compute a model of the predicted toxic threat zone and rendering the results electronically for visual display. The results are also distributed, or distributable, to users when parameters are updated, and users may be provided with displays of other related information associated with the toxic substance release or the release location.

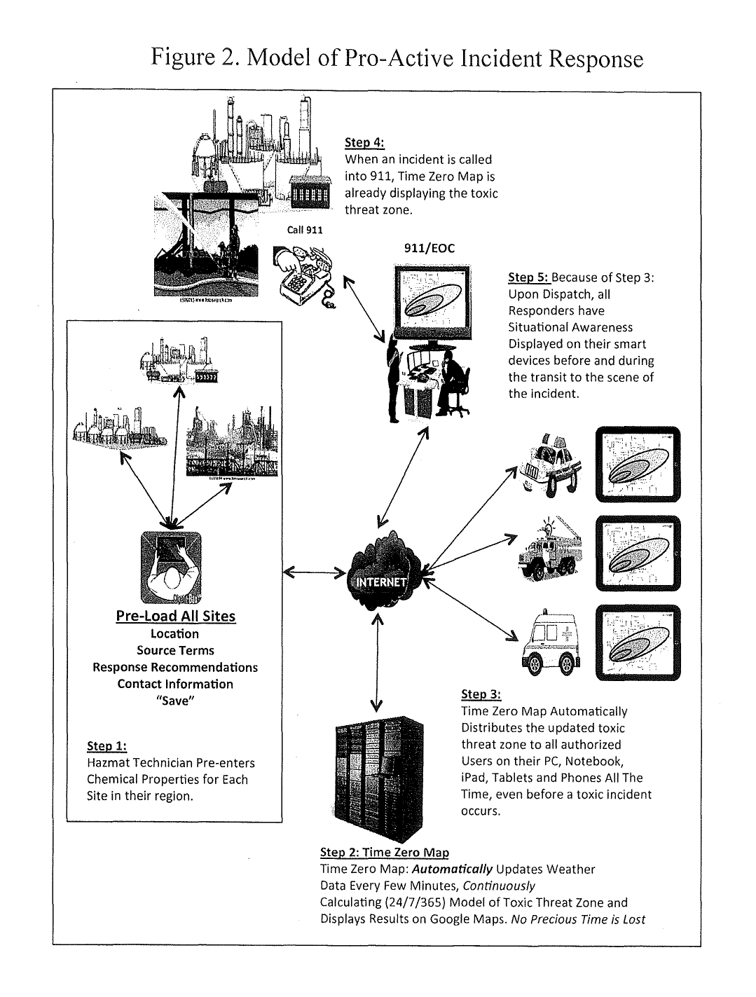

The system provides a pro-active method as described in connection with the illustration of FIG. 2: Pro-Active Incidence Response.

Step 1 of this method takes place before there is any hazardous substance released. A HazMat technician pre-enters both the locations and the chemical properties for each known facility storing hazardous substances in the region. Unlike the current approach where the HazMat technician enters the parameters associated with the toxic substance release into an application such as CAMEO/ALOHA only after the release is reported, the new method and system allows the HazMat technician to pre-enter all toxic facility site parameters. In this fashion, the parameters need to calculate a threat zone around a particular facility are immediately available, with the exception of weather.
a. Hazardous Site Information may include:
   1. Name of the site:
      a. Company Name
      b. Alias (For Security Reasons)
   2. Location of Site
      a. Click on Map (Map, Satellite, Earth)
         i. Google Maps, Yahoo! Maps, Bing Maps, MapQuest, OpenStreetMap, Nokia Here, Apple Maps, ESRI
      b. Lat/Long
      c. Address
   3. Key Contacts for Company Officials (Manager, Safety Manager, Facility Manger, Security)
      a. Name
      b. Title
      c. Address
      d. Phone Numbers
      e. Email Address
   4. Toxic Substance Source Terms (as many as necessary for the site. Many sites will have multiple toxic substances, especially storage facilities)
      a. Parameters such as molecular weight, threshold exposure limits, level that poses immediate danger to life and health, boiling point, vapor pressure, ambient saturation concentration may be collected from databases.
   5. Authorize who can see monitored sites
   6. Display Monitoring (while entering sites):
      a. For a specific site being worked on
      b. Multiple Sites
   7. First Responder Recommendations

The second step involves mapping the site locations and updating weather information relative to those locations. Based upon the weather data and calculations, the system then recalculates threat zone models for each site around the clock. The system associates each site location with one or more weather reporting stations, as from the weather reporting networks of NOAA, MADIS, or Weather Underground. To operate with Weather Underground, for instance, the system will uses the address or latitude and longitude data to acquire the zip code. The zip code is used to identify the nearest weather station in the Weather Underground personal weather station network. Weather Underground sends back the current weather to system from each requested weather station location. Weather data for each site is retained for calculations over a time interval ranging from one to about 72 hours. This weather data is processed algorithmically to produce the probable wind, temperature, humidity, cloud cover, barometric pressure and other available parameters that may affect the dispersal of hazardous substances. When possible the data from only a single time at a single weather station is not utilized because of the greater chance that the station has recorded a singular event such as a wind gust or lull that is not representative of actual conditions. Then by algorithmically processing several data points from one or more nearby weather stations to produce statistically meaningful weather parameters, and using a FEMA/EPA/NOAA certified algorithm such as those of ALOHA, INPUFF, TSCREEN, HYSPLIT, SLAB, CALPUFF, ARCHIE or ISC3, or industry models such as CHARM, PHAST, and SAFER, or even a proprietary modeling algorithm, and data associated with the respective toxic/hazardous material site, calculates a threat zone assuming a hazardous substance is being released into the atmosphere at that instant in time. Thus the system has prepared in advance a threat zone that would be applicable to each site that has been input into the system, and for each hazardous substance at the site.

Once the algorithm has calculated the model of the toxic threat zone is rendered for display on a mapping system such as, Google, ESRI and others, or other multi-dimensional coordinate systems to be displayed in or on any appropriate medium, most commonly a viewing screen or printed report. The system repeats the process for each chemical in each site entered into the system, as by a HazMat technician, and updates the calculations and threat zone rendering on an ongoing basis as additional weather data is processed or modifications are made to site and hazardous material information.

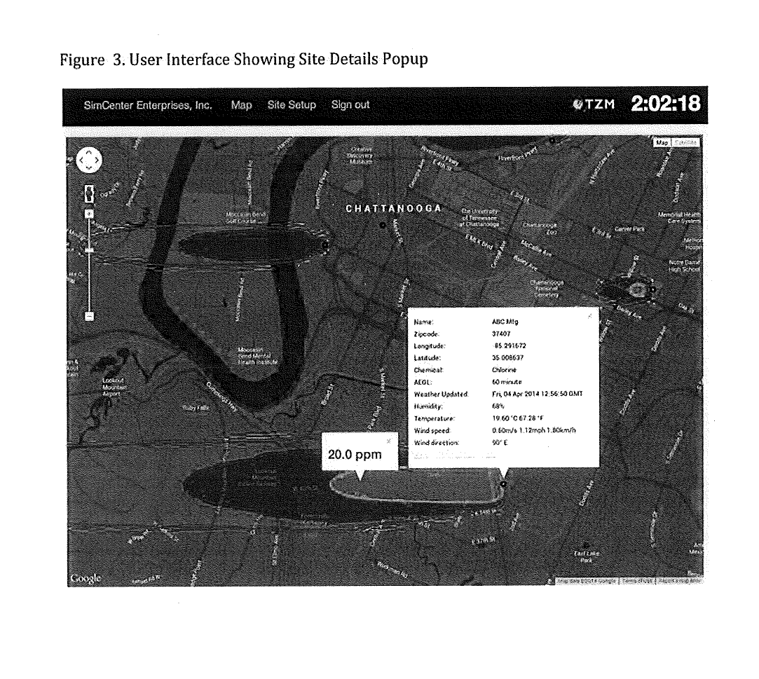

In the third step, the system distributes the updated toxic threat zone to authorized users on their PC, notebook, tablet and smart phone devices. Unlike current processes where the HazMat technician is the only person able to view the threat zone renderings on a computer or other device, the new system and method is able to distribute the model of the toxic threat zone (calculated in Step 2) via the internet to all authorized users to be displayed on a PC or mobile device, such as a tablet or smart phone. In addition, other site information can be made available to users, identifying other types of hazardous materials on premises, facility contact information, and response recommendations. All first responders now have the benefit of gaining situational awareness and a common operating picture thus allowing them to determine the safest route to the location and better understand appropriate options for addressing the situation. Authorized users, such as first responders, may even view this information when there is no release of toxic material in progress to develop an awareness of the types of situations that could arise. So, for instance in FIG. 3, threat zones that would be applicable to three different facilities are shown, and a detail popup for the facility named ABC Mfg. is displayed.

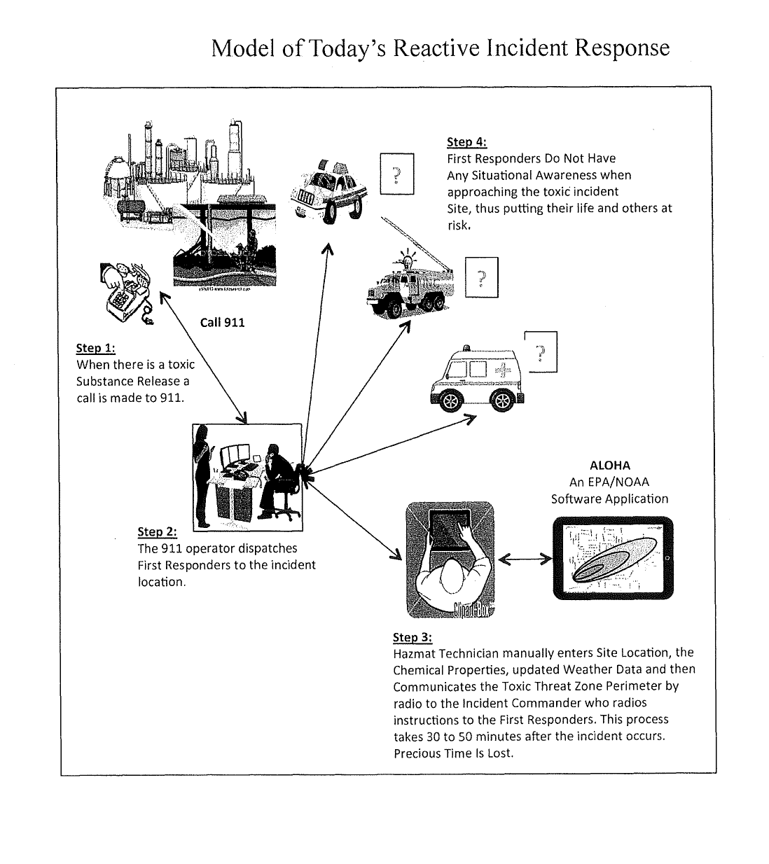

The fact that the fourth step of FIG. 2 is the 911 call or other report alerting authorities to an incident, and that this is the same as the first step of the existing reactive model of FIG. 1, demonstrates the advance planning and pro-active nature of the improved method and system. The first three steps of the improved method are undertaken to avoid unnecessary delays in developing information needed to deal with the release of toxic materials. In the fifth step of the new method, responders are dispatched and will have situational awareness before they arrive at the scene of the incident. Because the system is engaged in an ongoing process of updating the weather parameters periodically, perhaps as frequently as every few minutes, and recalculating a model of the toxic threat zone available for distribution and viewing by all authorized users, this means that at any point in time when there is a toxic substance release at a facility, the system has an applicable threat zone model that has already been calculated. First responders need only access an appropriate device to immediately gain situational awareness, including a graphic representation of the computed threat zone, thus allowing them to determine safe routes to the scene of the incident, to route traffic, and to determine shelter in place and/or evacuation strategies.

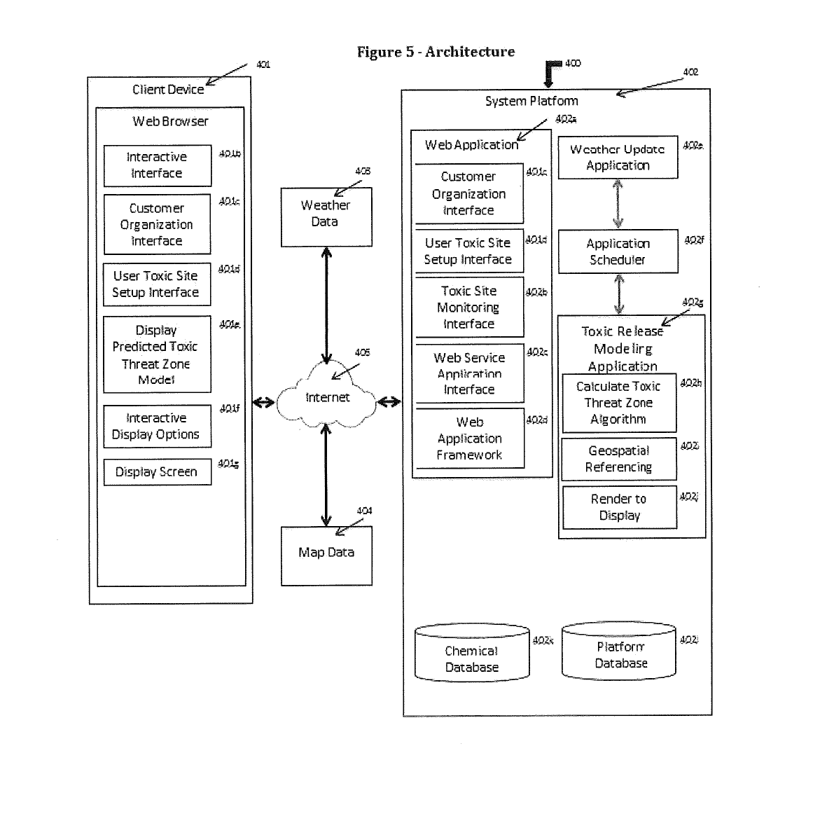

FIG. 5 illustrates the architecture of the major components of an implementation of the method and system 400. The method and system is designed to calculate, communicate, and display a real time model of toxic threat zones to user, in an on demand fashion on a web browser or similar interface. The system is immediately available for use in the event of a toxic substance release. The method and system provide for manually or electronically pre-entering facility location data, facility toxic substances, physical properties of the toxic substances, associated release parameters of the substances in the atmosphere, and historical, current or forecast weather applicable to the release of the substance at the present time. Furthermore the method provides for recalculating the results with updated data for any of the above data parameters using algorithmic modeling of toxic substance releases to have available at any point in time a then-current model of the predicted toxic exposure threat zone and a rendition of the results accessible electronically for visual display. The updated threat zone is distributable to users electronically or manually each time new input parameters are updated, and the capability of displaying other related information associated with toxic substance release and the release site facility, are provided.

The client device 401 is typically a personal computer, notebook computer, tablet, smart phone or other electronic device that provides a browser like access to the internet. Users access the system through a client device 401.

In the illustrated embodiment of the system, a user operates a web browser 401a on the client device 400 to access a system URL via the internet. The user will login into the system, typically using a unique user identification and password, but possibly via device recognition, biometric identification or other techniques. There are potentially several different user types. The same user may have multiple user type authorities and responsibilities. One user type is a customer administrator, who adds and deletes authorized users from an account. Another user type is the HazMat technician who is authorized to add or delete toxic substance facilities and to edit the associated information about the location of the facility, chemical properties, and other related information described in paragraph 0012 above). A third user type is the responder class of users who utilize the system in order to access information, but who do not modify the account or toxic substance facility information.

A customer administrator user is able to access a customer organization interface 401c, to enter information about the customer organization (Company Name, Contact Information, Add/Delete Authorized Users and run reports).

A HazMat technician user is able to access a toxic site setup interface 401d. Such a HazMat technician user is able to add, delete, and edit toxic facility site information as described in paragraph 0012 above. After the name of a hazardous or toxic chemical is entered, the associated chemical properties may be obtained by the system from the chemical database 402K. The data entered in connection with each toxic facility site is saved in the platform database 402L.

The web service/application interface 402e receives the information and sends the information to the application scheduler 402f. The application scheduler 402f performs several functions, as follows:
1. Accesses the platform database 402L to determine if any active toxic facility sites require weather updates and recalculation of the associated toxic threat zone.
2. If there is an active toxic facility site to be updated, the application scheduler 402f calls the weather update application 402e to send a request via the web service application interface 402c to the web based weather data content provider 403 (Weather Underground, NOAA, etc.) to retrieve the current weather conditions associated with the location of the toxic facility site and store the data in the platform database 402L. It will be understood that the platform database 402L may be unitary or may be segmented into related sub-databases. So, for instance there may be separate databases of customer organizations, user accounts, toxic facility sites, threat zone contours, and weather station data that are appropriately related for processing.
3. When the weather is retrieved and stored, the application scheduler 402f calls on and invokes the toxic release modeling application 402g.

The weather update application 402e not only obtains weather information from one or more weather data content providers 403 but also formats the information for use by other modules. Optimally, the weather update application 402e applies an algorithm to both the currently retrieved and recent historical data to produce averaged data that is likely representative of the conditions at a particular weather station or associated toxic facility site.

The toxic release modeling application 402g performs the following functions:
1. For a toxic facility site entry being updated the calculate toxic threat algorithm 402h accesses the name of the chemical, the associated chemical properties, the amount and duration of the toxic chemical release, latest weather data, and then performs the calculation to provide the data to model the toxic threat zone.
2. Then the toxic release modeling application 402g invokes the geospatial referencing application 402i to align the data for the toxic exposure threat zone to the coordinates on the map associated with the location of the toxic facility site and stores the information in the platform databases 402L.
3. Then the toxic release modeling application 402g calls and invokes the render to display application 402j to render the graphic representation of the toxic threat zone to be displayed over or in a coordinate mapping system such as Google, ESRI, MapQuest, etc. and stores the information in the platform databases 402L. The map data 404 is retrieved from a mapping content data provider via the web service application interface 402c and stored in the platform databases 402L.

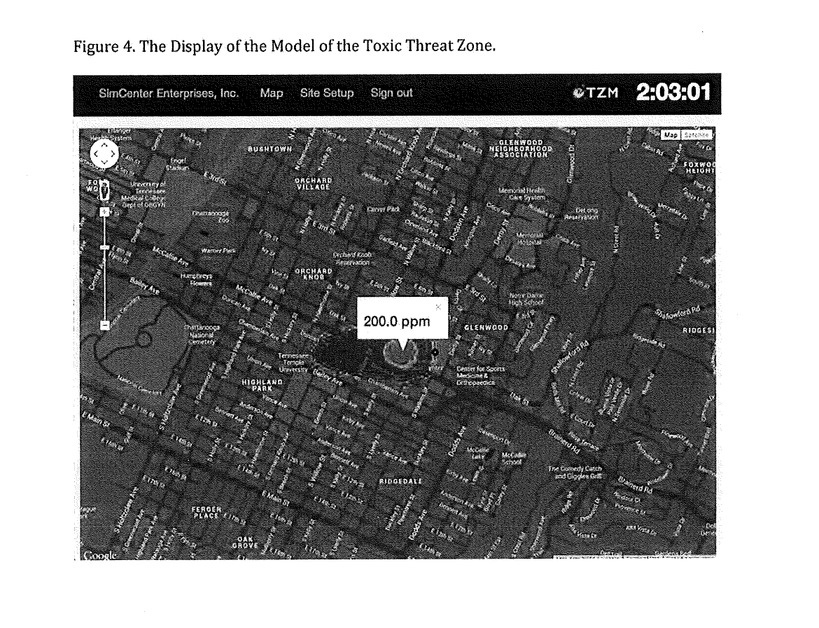

The application scheduler 402f then invokes the toxic site monitoring interface 402b to send the toxic threat zone representation to the client device 401 via the web service application interface 402c. The toxic threat zone representation is thereby made available to the web browser 401a on the client device 401 and to the display predicted threat zone model interface 401e for display on the client device display 401g providing a visual representation as depicted in FIG. 4—the Display of the Model of the Toxic Threat Zone. Typically the threat zone representation relative to an active incident is provided by the web service application interface 402e as a push service to the application running on the client device 401. Other information, such as updated threat zone representations for toxic facility sites not being examined by the user, or popup data available for toxic facility sites, may in some instance be more suitably provided on request from the client device 400 as a pull service, especially for regions with numerous toxic facility sites and users.

The web application 402a is responsible for providing all of the services that are accessed by the users via client devices' browser 401a. The web application 402a can be scaled for use with thousands of accounts and users in connection with thousands of sites.

The toxic site monitoring interface 402b provides a map of threat zones to client devices 401 that are configured for display to the user in the user toxic site setup interface 401d. The interface 401d presents the data to a user as a composite map with chemical release information, threat zone overlay on the map, current weather, and site information.

As has been noted above, the web service application interface 402c provides a mechanism where components of the system platform 402 may interact with each other and online databases to obtain information about chemicals, sites, users, and weather data in a standardized fashion.

The web application framework 402d is a software application that is designed to support the development of dynamic websites, web applications, web services and web resources. The framework aims to alleviate the overhead associated with common activities performed in web development. Both open source and proprietary web application frameworks are readily available and suitable for use in the system.

Interactive display options 401f on the client device 401 enables and allows the user to optionally select and display the toxic threat zone representations on the map. Additionally, the user may select different types of maps (street, terrain, satellite, etc.) for the display. In the event of an active toxic material release, the default user display will show the toxic threat zone for the active incident. In the event that the user is not engaged in responding to the incident, the user may operate the display options 401f to choose not to display that threat zone.

Numerous alterations of the systems and methods herein disclosed will suggest themselves to those skilled in the art. However, it is to be understood that the present disclosure relates to a present embodiment of the invention which is for purposes of illustration only and not to be construed as a limitation of the invention. All such modifications which do not depart from the spirit of the invention are intended to be included within the scope of this disclosure.

We claim:

1. A system and method for the nearly continuous modeling and dissemination of threat zones associated with hazardous release materials comprising a system platform;
a database of hazardous site information;
periodically updating weather data associated with hazardous site locations;
utilizing an algorithm to calculate a threat zone for hazardous site locations;
rendering the threat zones associated with hazardous site locations to a mapping system;
distributing updated threat zone information to users via communication network.
